(19) United States
(12) Patent Application Publication
(10) Pub. No.: US 2020/0074408 A1
(43) Pub. Date: Mar. 5, 2020

(54) SYSTEM FOR CONNECTING TUTORS AND STUDENTS

(71) Applicant: GoPeer, Providence, RI (US)

(72) Inventors: Ethan Binder, Providence, RI (US); Zurabi Mestiashvili, Tbilisi, GA (US); Erik Laucks, Lebanon, PA (US)

(21) Appl. No.: 16/556,649

(22) Filed: Aug. 30, 2019

Related U.S. Application Data
(60) Provisional application No. 62/724,755, filed on Aug. 30, 2018.

(51) Int. Cl. G06Q 10/10; G06F 16/953

(52) U.S. Cl. CPC G06Q 10/1093; G06F 16/953

(57) ABSTRACT

A system connects a student with a tutor. The system includes a user account database. The user account database stores data pertaining to a plurality of tutor accounts and a plurality of student accounts. The data includes the tutor's travel policy, subject matter area, and hourly rate. A search engine receives a search query from a student account for the tutor's subject matter area. The search engine weighs the tutor accounts based on at least the tutor's travel policy, the tutor's subject matter area, and a student's location. A user interface server displays the tutor accounts in response to the request. A scheduling engine receives a request for a tutoring session at a specified location and a specified. The scheduling engine also receives a confirmation from the other party. A transaction confirmation engine sends a request for confirmation of the tutoring session after the specified time.

### PRIORITY

This patent application claims priority from U.S. Provisional Application No. 62/724,755, filed Aug. 30, 2019, entitled “System for Connecting Tutors and Students,” assigned attorney docket number 130659-00201 (formerly 4413/01002), and naming Ethan Binder, Zura Mestiashvili, and Erik Laucks as inventors, the disclosure of which incorporated herein, in its entirety by reference.

### FIELD OF THE INVENTION

The invention generally relates to a platform for connecting students and tutors and, more particularly, the invention relates to finding qualified tutors in a geographic area and scheduling a tutoring session.

### BACKGROUND OF THE INVENTION

Students in schools from grades K-12 study diverse subject matter with varying levels of detail. Subject matter and level of detail may vary based on, for example, type of school (e.g., public or catholic school), geographic region, student grade, type and level of course, among other things. Thus, the level of tutoring assistance required by each individual student may vary.

### SUMMARY OF VARIOUS EMBODIMENTS

In accordance with one embodiment of the invention, a system for connecting a student with a tutor includes a user account database server. The user account database server is configured to store data pertaining to a plurality of tutor accounts and a plurality of student accounts. The data pertaining to each tutor account includes the tutor's travel policy, subject matter area, and hourly rate. The system also includes a search engine configured to receive a search query from a student account for the tutor's subject matter area. The search engine has a ranking algorithm that weighs the tutor accounts based on at least the tutor's travel policy, the tutor's subject matter area, and a student's location. The system further includes a user interface server configured to display the tutor accounts in response to the request based on the ranking algorithm. A scheduling engine is configured to receive a request for a tutoring session at a specified location and a specified time from one of the student account or the tutor account. The scheduling engine is further configured to receive a confirmation for the tutoring session from the other one of the student account or the tutor account. A transaction confirmation engine is then configured to send a request for confirmation of the tutoring session to the student account and to the tutor account after the specified time.

In some embodiments, the ranking algorithm weighs: the number of tutoring sessions, cumulative ranking, subject area, zip code, traveling policy, college, date, and time. In some embodiments, the search query includes at least one of subject area, zip code, travel policy, tutor university, or tutoring session date and time.

In some embodiments, the scheduling engine may facilitate instant messaging between the tutor account and the student account.

In some embodiments, the transaction confirmation engine is configured to send a request for a rating of the tutor.

In accordance with another embodiment of the invention, a method for connecting a student with a tutor stores data pertaining to a plurality of tutor accounts and a plurality of student accounts in a user account database server. The data pertaining to each tutor account includes the tutor's travel policy, subject matter area, and rate (e.g., hourly rate). The method receives a search query for a tutor in a search engine from a student account. The search engine has a ranking algorithm, and the method ranks the tutor accounts based on at least the tutor's travel policy, the tutor's subject matter area, and the student's location. The tutor accounts are displayed based on the ranking in response to the request. A request to schedule a tutoring session at a specified location and a specified time is received by the system from one of the student account or the tutor account. The tutoring session is scheduled when the other one of the student account or the tutor account confirms the session. The system requests confirmation of the tutoring session from the student account and the tutor account after the specified time.

Illustrative embodiments of the invention are implemented as a computer program product having a computer usable medium with computer readable program code thereon. The computer readable code may be read and utilized by a computer system in accordance with conventional processes.

### BRIEF DESCRIPTION OF THE DRAWINGS

Those skilled in the art should more fully appreciate advantages of various embodiments of the invention from the following “Description of Illustrative Embodiments,” discussed with reference to the drawings summarized immediately below.

FIG. 1 schematically shows details of a platform for connecting students and tutors in accordance with illustrative embodiments of the invention.

FIG. 2 schematically shows a map with a student location having a radius in which the student is willing to travel in accordance with illustrative embodiments of the invention.

FIG. 3 schematically shows a map with tutor locations having a radius in which the tutor is willing to travel in accordance with illustrative embodiments of the invention.

FIG. 4 is a flowchart schematically illustrating connecting a student and a tutor for a tutoring session in accordance with one exemplary embodiment of the invention.

FIG. 5 schematically shows a tutor profile in accordance with illustrative embodiments of the invention.

FIG. 6 schematically shows a student profile in accordance with illustrative embodiments of the invention.

### DESCRIPTION OF ILLUSTRATIVE EMBODIMENTS

In illustrative embodiments, an online platform allows students in grades K-12 to search for and connect with tutors. The students may search for tutors, for example, by academic institution, major area of study, geographic area and/or GPA. A weighting system ranks tutor profiles and provides relevant search results. Students may review the tutor profiles to select an appropriate tutor. Tutor profiles may include details regarding qualifications with respect to tutoring ability, a description of the tutor, proficiency in the subject matter, and other information. Students can select a tutor of their choice and schedule an in-person tutoring session on the platform. Additionally, or alternatively, students may schedule an online tutoring session, which may include video chat and an online eraser board provided by the platform. Details of illustrative embodiments are discussed below.

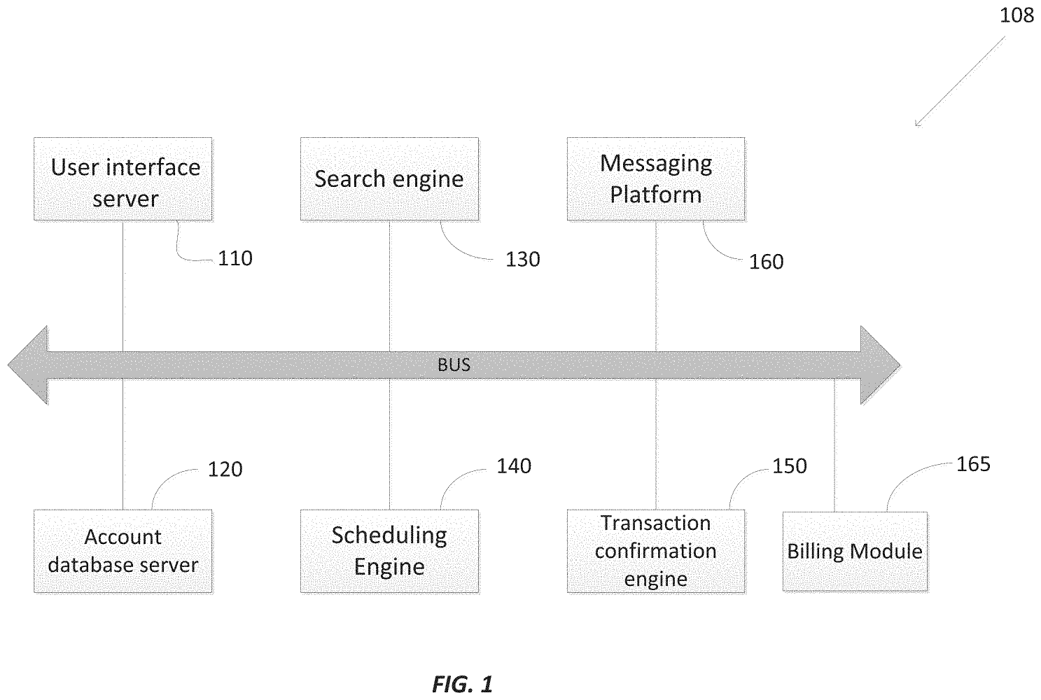

FIG. 1 schematically shows details of a platform 108 for connecting users in accordance with illustrative embodiments of the invention. The users of the platform 108 may be, for example, students who are looking for a tutor, and tutors who want to offer their services to the students. Although the user classes are divided into “students” and “tutors,” it should be understood that the tutors may also be enrolled at an academic institution (e.g., college students). However, for the purposes of this description, “students” refers to users who are seeking to be tutored, and “tutors” refers to users who wish to offer their tutoring services (regardless of the tutor's status as a student at an academic institution).

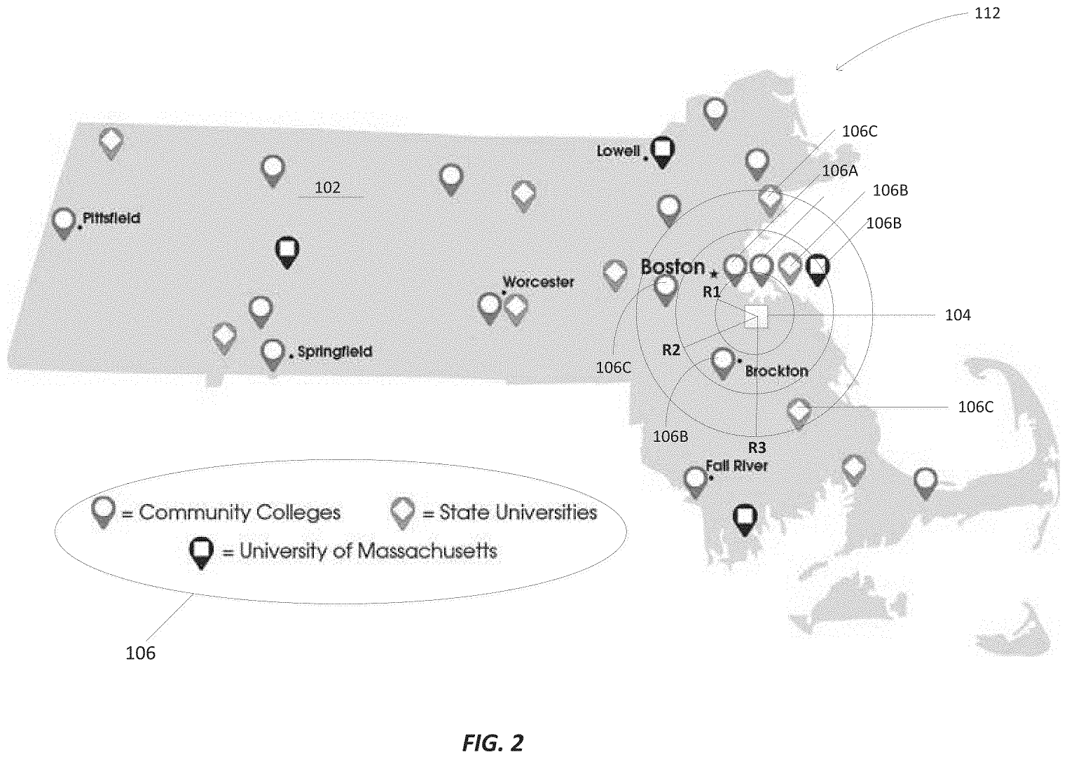

The platform 108 has a user interface server 110 that provides a user interface (an example of which is shown as 112 in FIG. 2) to the user. The user interface 112 may be provided in the form of a web page and associated code (e.g., Java, JavaScript), and may be accessed by a user device. The user device can be any communication device that can connect to a network and send and receive data, such as a cellular phone, computer, tablet, etc. The user device preferably includes a web browser and can display webpages and execute associated computer code. Preferably, the user device may receive and transfer data between the user device and the platform 108.

Users may create an account and edit their account information on the platform 108 through the user interface 112. To that end, users may register as a student, a tutor, or a parent. Depending on the type of registration, the user interface may appear differently. The user interface server 110 communicates with an account database server 120, which stores data pertaining to the user accounts. The data stored includes the user's account information entered at the time of registration. As an example, for tutors, this data may include age, sex, location, a description of the tutor, details regarding qualifications with respect to tutoring ability, proficiency in the subject matter, travel policy, and/or other information.

Students may search for a tutor by accessing the search engine 130 through the user interface 112. The search engine 130 communicates with the account database server 120 to access the various user profiles, and filters search results based on the stored data. An example of a search is described below.

FIG. 2 schematically shows a map 102 with a student location 104 in accordance with illustrative embodiments of the invention. The student may input a radius in which the student is willing to travel. Although a map 102 is shown, it should be understood that not all embodiments have a visual representation of a map. Furthermore, some embodiments may merely require an address, a city, and/or a state.

The map 102 may be displayed in the user interface 112 of the online platform 108. Although the illustrated map 102 shows Massachusetts, it should be understood that illustrative embodiments of the map 102 are not limited to Massachusetts. Nor are illustrative embodiments limited to a single state. The map 102 may show, for example, the entire world, the United States, New England, an individual state, county, city, or town. In illustrative embodiments, users may zoom in and out of the map 102 to alternate between the above described geographies.

Depending on whether the student wishes to travel to meet the tutor or have the tutor come to meet them, or to have online/virtual tutoring, the platform 108 may provide different search settings. For example, if the student wants to meet at a certain location 104, or is willing to travel, the student may set a search for a tutor within a geographic radius (e.g., R1, R2, R3, etc.) of the student's location 104. A hypothetical student may provide their location 104 at the time of registration with the platform 108 and/or at the time of the search. The student's location 104 may include, for example, their home address, a proposed meeting place (e.g., a located curated by the system), or a zip code. In some embodiments, the platform 108 curates safe tutoring locations. Thus, users can select to host their tutoring session at any of the curated locations near them.

A range of factors, including accessibility, safety, and availability are considered when curating locations. Locations are curated through partnerships with local businesses, colleges, and universities. Each curated location may be researched and inspected to make sure it complies with the criteria for a curated location. After tutoring sessions take place at a selected curated location, both students and tutors may provide comments and/or reviews about the location through the platform 108. Based on the feedback, a specific location can lose its approved curated status.

Students may also set a radius R1 (e.g., 10 miles) within which they want to look for tutors. A blank search for all tutors within radius R1 would return all of the registered tutors within that radius R1. In some embodiments, all of the registered tutors are associated with an institution of higher learning 106. Thus, all of the tutors registered at the community colleges 106A within the 10 mile radius would appear to the user through the interface 112.

A broad search for all tutors within radius R1 may return a large number of hits. Students may also filter the results through the search engine 130. For example, the hypothetical student may be looking for a biology tutor. The student can filter the search results through the user interface 112 to look for a biology tutor.

If the student is unsatisfied with the results of the first search in the example provided above (e.g., none of the registered tutors at community colleges 106A are biology tutors), they may expand their search within a new radius R2 (e.g., 20 miles). This new search would include the results of tutors from the community colleges 106A as well as the new universities 106B.

The student may scroll through the search results filtered for biology tutors. The student may apply additional filters to the search results through the search engine 130. For example, the student may want a biology tutor who can travel to the student's location 104, or may want the biology tutor to have a 5-star rating. The student may enter this criteria into the search engine 130, which communicates with the account database server 120 to identify tutor accounts that meet the search criteria. The account database server 120 holds data about, for example, the tutor's travel policy and student-rating. If, for example, none of the tutors within radius R2 have a 5-star rating and are willing to travel to the student's location 104, the system may display no results. The system however may suggest expanding the radius to R3 (e.g., 30 miles).

If the student expands the search to radius R3, all of the results within radius R1 and R2 are included, in addition to registered tutors associated with universities 106C. If multiple tutors fit the criteria within radius R3, they may be displayed on the user interface 112. The search engine 130 may also have a relevancy algorithm that determines the order in which relevant results are displayed.

Although the above process describes filtering in sequence, it should be understood that all of the filters can be applied at a single time. The description of applying different filters in stages is merely intended to facilitate the discussion of the operation of the system.

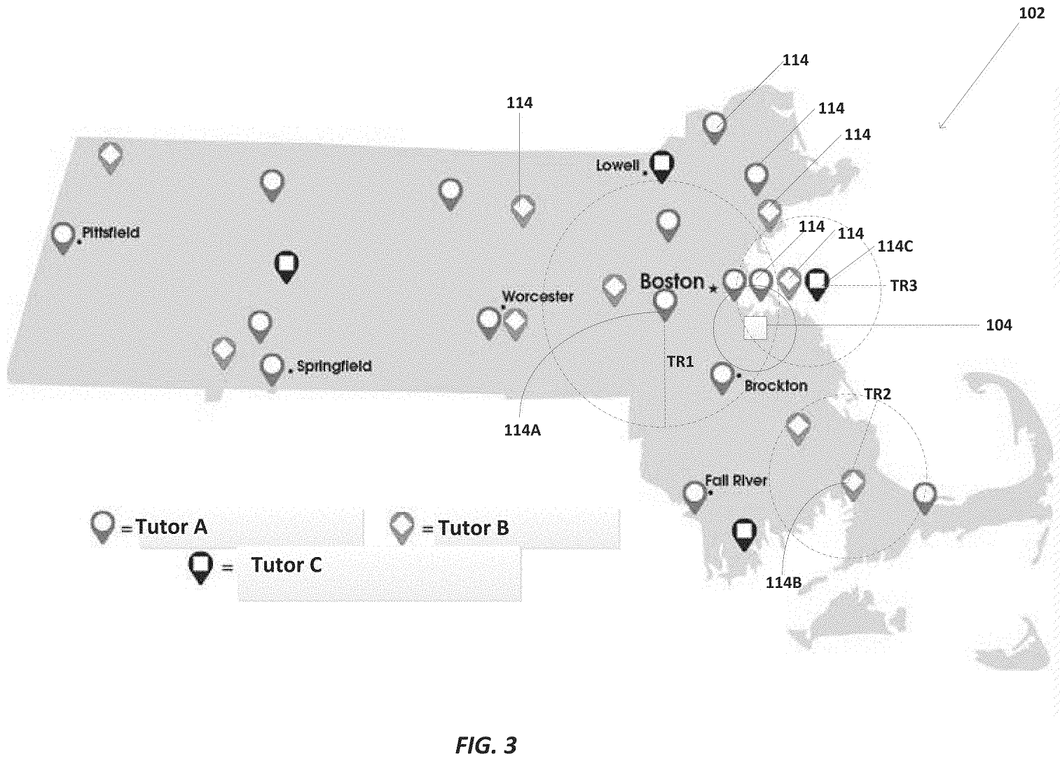

FIG. 3 schematically shows a map 102 with tutor locations 114 having a radius in which the tutor 114 is willing to travel in accordance with illustrative embodiments of the invention. If the student does not wish to travel to meet the tutor (e.g., if the student is too young to drive), the tutor may travel to the student. When tutors register with the platform 108, the tutors may set up a travel policy that is stored in the account database server 120. The travel policy is a radius zone (e.g., TR1, TR2, and TR3) within which the tutor is comfortable traveling to and hosting tutoring lessons. Travel policy distances may be used in the ranking algorithm when filtering tutors for search requests.

The student may search for a tutor 114 who has a travel policy that includes the student's location 104. Alternatively, the system may automatically filter search results to make sure that the student's location 104 is within the tutor's 114 travel policy. For example, perhaps only three biology tutors 114A, 114B, and 114C are registered. In illustrative embodiments, when the student searches for a biology tutor 114A, 114B, and 114C, only tutors 114A and 114C show up in the search results, because the student is within their travel radius TR1 and TR3. In some other embodiments, tutor 114B may also appear in the search results (e.g., at the end of the results). In some other embodiments, the student may also enter a travel radius (e.g., R3), and the search engine displays results for tutors who's travel radius (e.g., TR1, TR2, and TR3) overlap with the student's travel radius.

The ranking algorithm may account for, but is not limited to, one or more of the following: number of tutoring sessions the tutor has completed, cumulative rating, subject area, zip code, travel policy, tutor university/college, date, and time. Furthermore, the weighing algorithm may take into account student data, and not just tutor data. For example, the type of assistance required and the student's education level may be quantified and associated with the request criteria that correspond(s) to the search result criteria. The weighting system combines the quantified information associated with the criteria to select and display the tutors that fit the user's needs best. The weighting system may further include objective relative weights, input from the student's parent, and/or the student. The availability of the tutors is also taken into account in selecting a tutor. The travel policy and college/university of the tutor are also taken into account in the search result criteria.

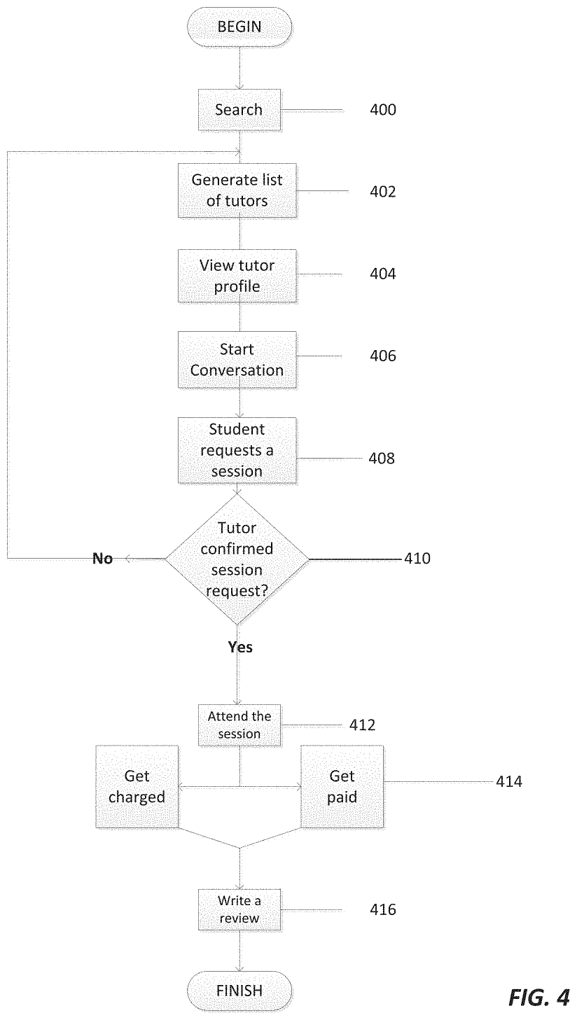

FIG. 4 is a flowchart schematically illustrating connecting a student and a tutor in accordance with one exemplary embodiment of the invention. It should be noted that this method is substantially simplified from a longer process that may normally be used. Accordingly, the method of FIG. 4 may have many other steps that those skilled in the art likely would use. In addition, some of the steps may be performed in a different order than that shown, or at the same time. Those skilled in the art therefore can modify the process as appropriate.

The process begins at step 400, where the student initiates a search for a tutor. The student may enter a search into the search engine 130 via the user interface 112. The student may search for tutors by, for example: age, grade, GPA, institution of higher learning, academic major, academic minor, subject area expertise, classes taken, rating, location (e.g., zip code), availability (e.g., tutoring session date and time), keyword, language spoken, etc. In some embodiments, results are automatically filtered to account for the tutor's travel policy.

In some embodiments, to register as a tutor the tutor must be currently enrolled at an institution of higher learning (e.g., 4 year colleges or universities). To that end, the tutor first fills out an online application. The tutor may then be screened via an online interview and/or personality check. Then, the tutors academic credentials and experience may be screened (e.g., request official transcripts and enrollment status be sent directly by the university). Additionally, or alternatively, a background check may be run on the tutor to check for criminal records. Thus, the searchable pool of tutors may consist of qualified pre-vetted tutors.

The process proceeds to step 402 which generates a list of tutors. To generate the list, the search engine 130 may communicate with the account database server 120 and/or the scheduling engine 140. The scheduling engine 140 allows tutors to set and update their availability schedule. The availability schedule may be used by the ranking algorithm when filtering tutors based off of user's searches. Accordingly, the list may be populated at the top by tutors who have the student within their travel policy and are available to meet during the requested time. Although illustrative embodiments are described as using a “ranking algorithm,” it should be appreciated that not all search results have to be ranked, and that some search results may be entirely excluded (e.g., if the tutor is not available or if the student's location is outside of the tutor's travel policy).

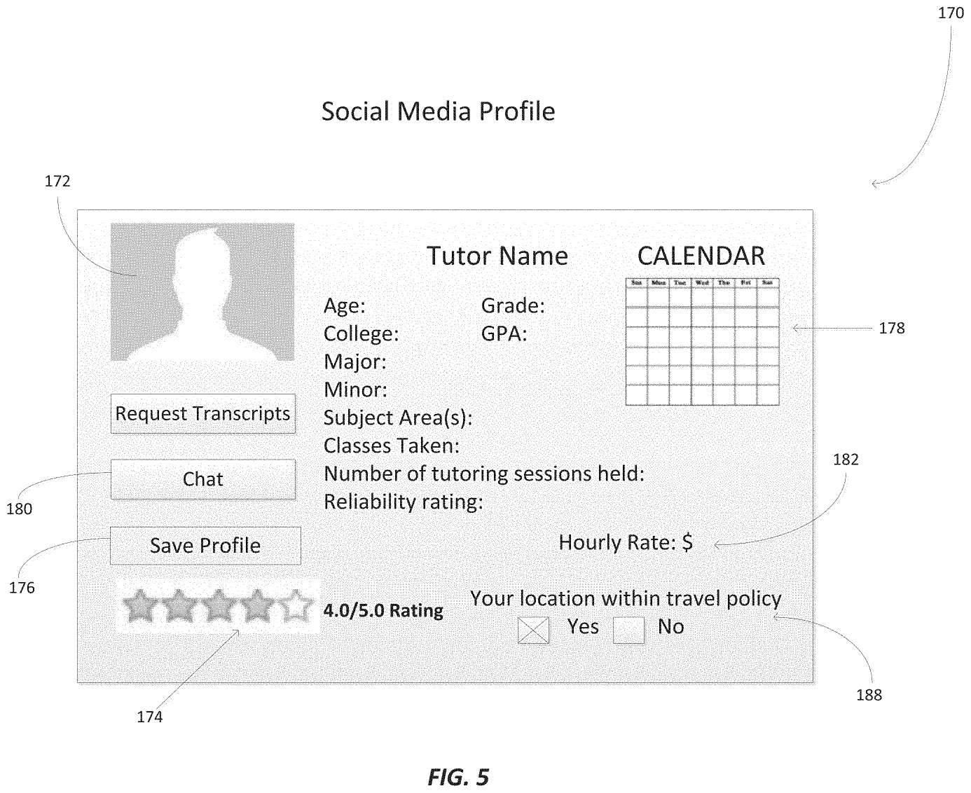

Once the list of tutors has been generated, the student may select to view the tutor's profile at step 404. FIG. 5 schematically shows a tutor profile 170 in accordance with illustrative embodiments of the invention. The tutor profile 170 may include a picture 172 of the tutor as well as the tutor's name. Other information in the profile 170 may include: an in depth biography, age, college the tutor attends, major, minor, subject area(s) the tutor can teach, classes taken, tutors location (e.g., city and state), number of tutoring sessions hosted, grade (e.g., junior), background check badge, high school and college educational timeline, student satisfaction rate, reliability rating (e.g., how often does the tutor show up to the tutoring session and/or show up on time), and tutor GPA. A tutor rating 174 may also be visible to the student. Clicking on the tutor rating 174 may allow the student to see reviews left by other students and parents. Parent users may also see the tutor profile 170. In some embodiments, the student may be able to request the tutor's transcripts to see the tutor's grade in a particular class. Furthermore, users who are considering working with the tutor may contact other users who are considering working with the tutor (e.g., parents who are considering this tutor may contact parents who have already had experience with the tutor). The above described communications are facilitated by the messaging platform 160.

As discussed above, the system may determine whether the student viewing the profile is within the tutor's travel policy. A travel policy indicator 188 may indicate whether the student viewing the profile is within the tutor's travel policy.

Students may also be able to view the tutor's hourly rate 182. In some embodiments, tutors are subject to the pre-determined fixed rate. Students can choose the fixed rate they want to pay without negotiating. Tutors and tutoring schedule times are controlled, monitored and presented in automated messages to clarify the parameters of the platform to both participants. The scheduling engine 140 may communicate with a billing module 165 for accurate debit of credits and payments.

The student may review tutor profiles 170 until a satisfactory tutor is identified. The student may save the tutor profile 170 for review at a later time by clicking on save profile button 176. The student may view the tutor's calendar 178 and request a lesson. Requesting a lesson coordinates the available sessions for both tutors and students across all time zones. Thus, all participants see their local time for ease of scheduling. Furthermore, the scheduling process coordinates the booking and billing to ensure a quality learning experience with accurate transactions. The student may initiate a chat with the tutor by clicking on the chat button 180 in the profile 170.

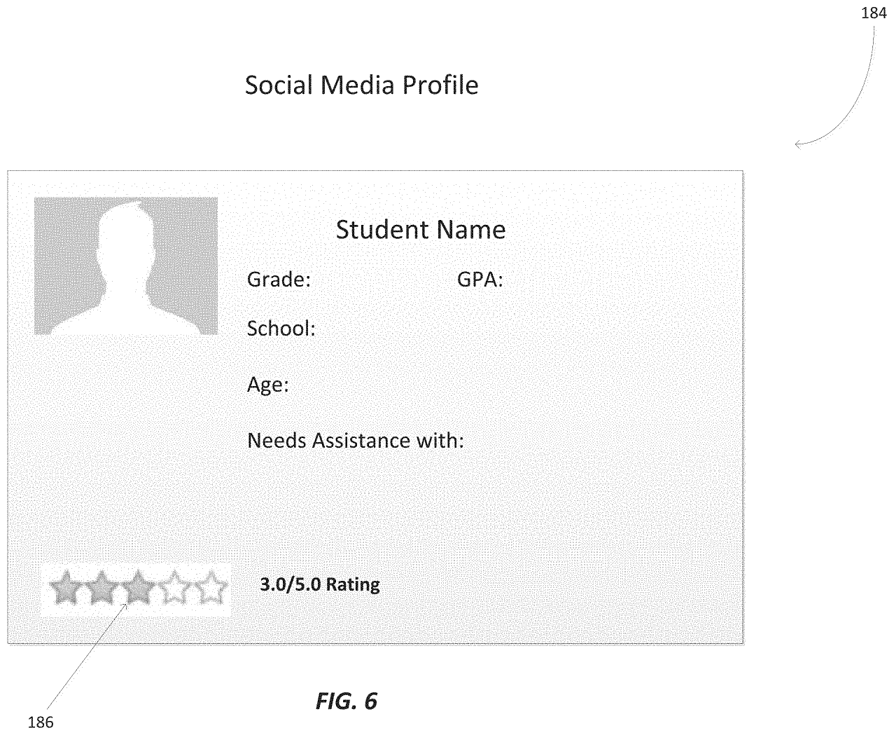

FIG. 6 schematically shows a student profile 184 in accordance with illustrative embodiments of the invention. In some embodiments, the tutor may view the student's profile 184 after being contacted by the student. This reduces the likelihood of a predator preying a young student, and also reduces unwanted marketing. The student profile 184 may also contain a rating 186 visible only to tutors. Tutors can leave commentary about students (e.g., late to appointments, auditory learner, suspected to be a fake account, etc.) As described above, for the safety of the students, the tutors may be pre-vetted before becoming searchable. In other words, the user account database 110 may communicate that tutors who are not approved should not pooled by the search engine 130. In some embodiments, the tutor may only view the student's profile 184 when contacted first.

The student may then start a conversation with the tutor at step 406. In some embodiments, the student and tutor can communicate only after a lesson is requested. In some other embodiments, the communication can be initiated before a lesson is requested. The student and the tutor can discuss the tutoring needs of the student (e.g., what classes require assistance), as well as choose a time, a date and a location to meet. The messaging platform 160 may allow the student and the tutor to chat instantly (via instant messaging chat box) or to email one another. Furthermore, parental settings may require that a parental user is also in the chat box (e.g., a chat room).

After a time and location for tutoring session has been selected, the student may request to book the session at step 408 through the platform. In some embodiments, the system may suggest a pre-screened safe tutoring location for the tutoring session. Alternatively, or additionally, the student or tutor may request that a location of their choice be screened and verified by the system. The process then proceeds to step 410, which asks if the tutor confirmed the tutoring session request. After step 408, the tutor is sent a request to confirm the booking. If the tutor denies the booking, the process may return to step 402, and the student may begin looking for a new tutor. Alternatively, or additionally, the student may return directly to step 408 and request to book a different session with the tutor (e.g., if the student accidentally request the wrong time or date).

If the tutor confirms the session, the scheduling engine 140 is updated to reflect that the tutor is booked during the request time slot. Additionally, or alternatively, the tutoring session may need to be confirmed by the parent. The next step 412 in the process is for the student and the tutor to attend the tutoring session. At the tutoring session, the student receives the requested tutoring at the agreed upon time and location from the tutor.

After the scheduled time has elapsed, a transaction confirmation engine 150 sends an email to confirm that the tutor and the student met for the tutoring session. In some embodiments, an email is sent only to the student. In other embodiments both the student and the tutor receive an email. In some embodiments, the transaction confirmation engine 150 may also send a survey email to the student. For example, the survey can ask whether the student was satisfied, whether the tutor made the appointment, whether the tutor showed up on time, request written comments and/or request a rating for the tutor. Once the answers are received, the transaction confirmation engine 150 can relay this information to the user account database 110 and automatically update, for example, the student satisfaction rating, the tutor reliability rating, the tutor review ranking. These updates may be reflected in the tutor profile 170.

After the student has confirmed that the tutoring session took place, the system charges the student and pays the tutor at step 414. The process then, optionally, moves to step 416 in which the student may write a review about the tutor. The student may provide written comments and a numerical or star-rating (e.g., a ranking out or 10.0 or a 5-star system). The transaction confirmation engine 150 logs the student's response and updates the tutor's rating in the account database server 120. The tutor's profile reflects his or her rating, which is viewable by other students. In some embodiments, the tutor may be asked to leave a review about the student as well. The process then comes to a conclusion.

In some embodiments, the platform is an online repository for learning and teaching materials for tutor access. This repository contains multimedia materials and links that may be consistently updated to remain current and relevant. The platform may display and suggest the online repository to tutors and students to keep them knowledgeable and updated on the information in the repository.

It should be reiterated that the representations of the platform in FIGS. 1-6 are a significantly simplified representation of the platform 108. Those skilled in the art should understand that such a device has many other physical and functional components, such as central processing units, packet processing modules, and short-term memory. Accordingly, this discussion is in no way intended to suggest that FIGS. 1-6 represents all of the elements of the platform 108.

It should be noted that FIG. 1 only schematically shows each of these components. Those skilled in the art should understand that each of these components can be implemented in a variety of conventional manners, such as by using hardware, software, or a combination of hardware and software, across one or more other functional components. For example, the scheduling engine 140 may be implemented using a plurality of microprocessors executing firmware. As another example, the scheduling engine 140 may be implemented using one or more application specific integrated circuits (i.e., “ASICs”) and related software, or a combination of ASICs, discrete electronic components (e.g., transistors), and microprocessors. Accordingly, the representation of the scheduling engine 140 and other components in a single box of FIG. 1 is for simplicity purposes only. In fact, in some embodiments, the scheduling engine 140 of FIG. 1 is distributed across a plurality of different machines—not necessarily within the same device.

Various embodiments of the invention may be implemented at least in part in any conventional computer programming language. For example, some embodiments may be implemented in a procedural programming language (e.g., “C”), or in an object oriented programming language (e.g., “C++”). Other embodiments of the invention may be implemented as a pre-configured, stand-along hardware element and/or as preprogrammed hardware elements (e.g., application specific integrated circuits, FPGAs, and digital signal processors), or other related components.

In an alternative embodiment, the disclosed apparatus and methods (e.g., see the various flow charts described above) may be implemented as a computer program product for use with a computer system. Such implementation may include a series of computer instructions fixed either on a tangible, non-transitory medium, such as a computer readable medium (e.g., a diskette, CD-ROM, ROM, or fixed disk). The series of computer instructions can embody all or part of the functionality previously described herein with respect to the system.

Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies.

Among other ways, such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). In fact, some embodiments may be implemented in a software-as-a-service model (“SAAS”) or cloud computing model. Of course, some embodiments of the invention may be implemented as a combination of both software (e.g., a computer program product) and hardware. Still other embodiments of the invention are implemented as entirely hardware, or entirely software.

Although the above discussion discloses various exemplary embodiments of the invention, it should be apparent that those skilled in the art can make various modifications that will achieve some of the advantages of the invention without departing from the true scope of the invention.

What is claimed is:

1. A system for connecting a student with a tutor, the system comprising:
a user account database server configured to store data pertaining to a plurality of tutor accounts and a plurality of student accounts, wherein the data pertaining to each tutor account includes the tutor's travel policy, subject matter area, and rate;
a search engine configured to receive a search query from a student account, the query including the tutor's subject matter area, the search engine having a ranking algorithm that weighs the tutor accounts based on at least the tutor's travel policy, the tutor's subject matter area, and a student's location;
a user interface server configured to display the tutor accounts in response to the request based on the ranking algorithm;
a scheduling engine configured to receive a request for a tutoring session at a specified location and a specified time from one of the student account or the tutor account, the scheduling engine further configured to receive a confirmation for the tutoring session from the other one of the student account or the tutor account; and
a transaction confirmation engine configured to send a request for confirmation of the tutoring session to the student account and to the tutor account after the specified time.

2. The system as defined by claim 1, wherein the ranking algorithm weighs at least one or more of the following: age, grade, GPA, institution of higher learning, academic major, academic minor, subject area expertise, classes taken, rating, tutor location, tutor availability, keyword, and language spoken,

3. The system as defined by claim 1, wherein the search query includes at least one or more of the following: age, grade, GPA, institution of higher learning, academic major, academic minor, subject area expertise, classes taken, rating, tutor location, tutor availability, keyword, and language spoken.

4. The system as defined by claim 1, wherein the scheduling engine facilitates instant messaging between the tutor account and the student account.

5. The system as defined by claim 1, wherein the transaction confirmation engine is configured to send a request for a rating of the tutor.

6. A method for connecting a student with a tutor, the method comprising:
storing data pertaining to a plurality of tutor accounts and a plurality of student accounts in a user account database server, the data pertaining to each tutor account including the tutor's travel policy, subject matter area, and rate;
receive a search query for a tutor in a search engine from a student account, the search engine having a ranking algorithm,
ranking the tutor accounts based on at least the tutor's travel policy, the tutor's subject matter area, and the student's location;
displaying the tutor accounts based on the ranking in response to the request;
receiving a request to schedule a tutoring session at a specified location and a specified time from one of the student account or the tutor account,
scheduling the tutoring session by confirm the request for the tutoring session from the other one of the student account or the tutor account; and
requesting confirmation of the tutoring session from the student account and the tutor account after the specified time.
